(19) United States
(12) Patent Application Publication
(10) Pub. No.: US 2023/0278591 A1
(43) Pub. Date: Sep. 7, 2023

(54) EMERGENCY STOP REQUEST CALCULATION TO BRING A VEHICLE TO A COMPLETE STOP

(71) Applicants: Steering Solutions IP Holding Corporation, Auburn Hills, MI (US); Continental Automotive Systems, Inc., Auburn Hills, MI (US)

(72) Inventors: Varunraj Arunrao Shedge, Auburn Hills, MI (US); Joseph A. LaBarbera, Auburn Hills, MI (US); Emmanuel Garcia, South Lyon, MI (US)

(21) Appl. No.: 17/688,188

(22) Filed: Mar. 7, 2022

(51) Int. Cl. B60W 60/00; B60W 50/02; B60W 10/04; B60W 10/18

(52) U.S. Cl. CPC B60W 60/00186; B60W 50/0205; B60W 10/04; B60W 10/18; B60W 2510/18; B60W 2520/10; B60W 2552/40; B60W 2510/20

(57) ABSTRACT

A number of variations disclose a system for implementing emergency stop functionality to bring a vehicle to a controlled stop when a vehicle's brake system, propulsion system, steering system, or motion control system are operating in a degraded state or are disabled or are unavailable. The system may account for external factors such as operating environment states including road surface mu, surrounding objects or other vehicles, or the like. Emergency stop functionality may be implemented when autonomous path trajectory or path planning is unavailable.

### TECHNICAL FIELD

The field to which the disclosure generally relates to includes steering, braking, and propulsion systems.

### BACKGROUND

Vehicles typically include steering systems including electronic braking systems. Emergency stop functionality within vehicles may allow for the complete stop of a vehicle in case of a failure of motion controls systems or steering systems.

The emergency stop safety function itself may become hazardous due to external environmental conditions or traffic conditions. In some scenarios, emergency stop requests may result in deceleration requests that are too aggressive resulting in destabilization of the vehicle that may lead to potentially hazardous scenarios. There is a need to address how vehicle systems can safely and gracefully stop the vehicle in case of motion controls system failure or steering systems failure.

### SUMMARY OF ILLUSTRATIVE VARIATIONS

A number of variations may include a system and method for calculating individual vehicle wheel brake torque or propulsion torque based on vehicle information such as, but not limited to, surface mu, steering position, health status of various actuators, and other vehicle information. The system may function to bring a vehicle to a controlled stop in a safe manner after detecting failure of motion control systems or steering systems, if longitudinal controls systems, such as brake or propulsion systems, fail, or if an automated driving system requests an emergency stop.

The system and method may be incorporated within a motion control algorithm in vehicle driving systems, or within brake electronic control units, or powertrain electronic control units, or the like.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation of a block diagram of a system and method for an improvement in an emergency stop request calculation.

### DETAILED DESCRIPTION OF ILLUSTRATIVE VARIATIONS

The following description of the variations is merely illustrative in nature and is in no way intended to limit the scope of the invention, its application, or uses.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

As used herein, “operating environment” may refer broadly to roadways, highways, streets, paths, parking lots, parking structures, tunnels, bridges, traffic intersections, residential garages, or commercial garages. It is contemplated that the operating environment may include any location or space accessible by a vehicle.

As used herein, “computing device” or “computer” may refer broadly to a system constructed and arranged to execute the processes and steps described in this disclosure. A computer device may include one or more processors in operable communication with memory through a system bus that couples various system components such as input/output (I/O) devices. Processors suitable for the execution of computer readable program instructions or processes may include both general and special purpose microprocessors and any one or more processors of any digital computing device. A computing device may include standalone computer or mobile computing device, a smart device, a mainframe computer system, a workstation, a network computer, a desktop computer, a laptop, or the like. A computing device may be a combination of components including a processor, memory, data storage, and the like in operable communication with a variety of systems within a vehicle such as, but not limited to, electronic steering systems, traction control systems, autonomous driving systems (ADS) and semi-autonomous driving systems, or the like.

In a number of illustrative variations, a vehicle may include a steering system comprising a steering interface and a steerable propulsion system such as but not limited to a steering wheel and road wheels, respectively. The steering system may be of the electric power steering type wherein physical linkages mechanically communicate a manipulation of the steering interface to the steerable propulsion system. The steering system may be of the steer-by-wire type wherein physical mechanisms do not mechanically communicate a manipulation of the steering interface to the steerable propulsion system and wherein a manipulation of the steering interface affects an associated manipulation of the steerable propulsion system via the communication of electronic devices such as but not limited to sensors, transceivers, and electronically excited actuators. In some scenarios, a driver may be driving a vehicle with a normally functioning electric power steering system and the electric power system controller or electric power system motor, actuator, or the like may fail or shut down so that it provides no motor output that can assist the driver in steering the vehicle. In such scenarios, it may be necessary to implement emergency stop functionality to bring a vehicle to a controlled stop. According to some embodiments, a steering system may be integrated with respective controllers or electronic control units (ECU) as necessary.

In a number of illustrative variations, a vehicle may be driven ahead by a propulsion system derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement. According to some embodiments, a propulsion system may be integrated with respective controllers or ECUs as necessary.

In a number of illustrative variations, a vehicle may include an electric braking system constructed and arranged to apply brake pressure to any number of road wheels to assist in steering a vehicle based upon driver steering interface input. The electric braking system may be in operable communication with the steering system and road wheel actuator assembly via at least one controller. According to some embodiments, a braking system may be integrated with respective controllers or ECUs as necessary.

In a number of illustrative variations, a vehicle may include a motion control system, motion controller, or autonomous driving system programmed with any number of logic modules arranged to autonomously address a number of areas of control within the realm of vehicle steering, propulsion, braking, and travel including but not limited to vehicle acceleration, vehicle braking, and an autonomous steering system for at least lateral or longitudinal control of the vehicle. In some scenarios, a driver may be driving a vehicle with a normally functioning motion control system and the motion control system may fail or shut down. In such scenarios, it may be necessary to implement emergency stop functionality to bring a vehicle to a controlled stop.

A number of variations may include a system and method including communicating, via at least one electronic processor, a request for an emergency stop where the system has determined that at least one of a steering system is disabled or in a failure state, a motion control system is disabled or in a failure state, an autonomous path trajectory is unavailable, disabled, or in a failure state, the propulsion system is disabled or in a failure state, the brake system is disabled or in a failure state, or an emergency stop request from a vehicle level ADS is present. The system, including at least one electronic processor, may be in operable communication with a variety of sensors within a vehicle such as, but not limited to, proximity sensors, cameras, global positioning and location data sensors, road surface sensors, steering position sensors, or the like. The system may also be in operable communication with the aforementioned vehicle systems to receive information such as, but not limited to, health state steering systems, braking systems propulsion systems, or motion control systems as well as existing emergency brake requests communicated from and ADS. The system may be carried out by at least one or multiple ECUs including, but not limited to, braking system ECUs, trajectory planning ECUs, and actuator controllers depending on the failure mode detected by the system.

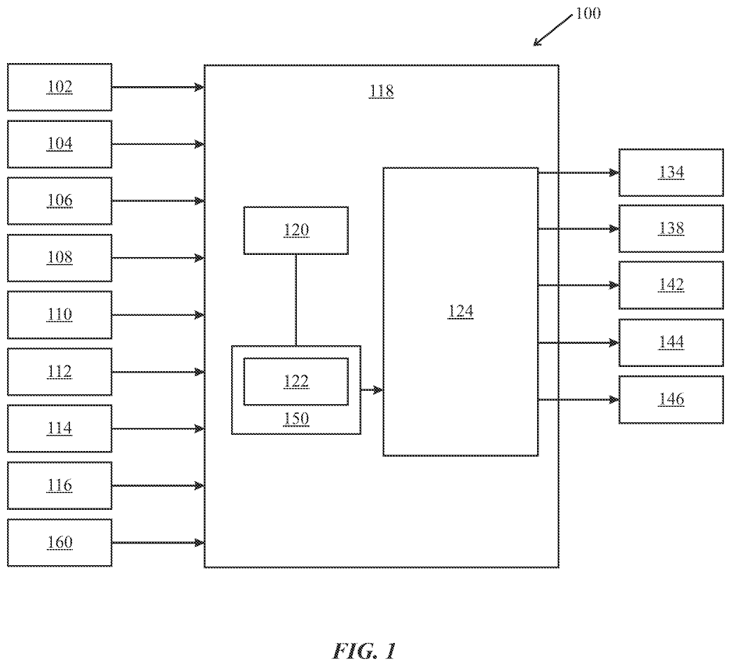

FIG. 1 depicts an illustrative variation of block diagram of a system and method of calculating the need for an emergency stop function in a vehicle. The system may include at least one processor or electronic control unit in combination with memory, the ECU being constructed and arranged to execute computer executable components. The system 100 may include an emergency stop calculation module 118 constructed and arranged to receive various inputs from a plurality of sources. Inputs may include local object detection information 102, surface mu information 104, current or last known steering position 106, steering system health status or motion control system health status 108, brake system health status or propulsion system health status 110, vehicle speed 112, current trajectory information or last known trajectory information 114, or emergency brake requests 116 communicated from autonomous driving systems. Inputs 160 may further include vehicle propulsion system status, autonomous driving mode active or inactive status, or autonomous driving path trajectory availability status.

The emergency stop calculation 118 may determine the availability of the emergency stop function 120 or unavailability of the emergency stop function based on information communicated to or from any of various ECUs within a vehicle. The emergency stop calculation 118 may implement emergency stop activation logic 122 and communicate an emergency stop activation request to emergency stop request activation module. The emergency stop activation logic 122, as part of an emergency stop request activation module 150, may determine if at least one of the steering system, motion control system, autonomous path trajectory planning system, propulsion system, brake system, or autonomous driving mode system are operating in a degraded state, inactive, failed, or the like. The emergency stop request activation module 150 may activate emergency stop functionality.

The brake torque and propulsion torque request module 124 may determine individual wheel brake torque requests 134 and propulsion torque requests 138 to be communicated to at least one controller within the vehicle. The brake torque and propulsion torque request module 124 may determine and communicate an emergency stop function availability signal 142, emergency stop function active or inactive signal 144, or electronic parking brake active or inactive signal 146. Brake torque and propulsion torque requests may be determined where the system has determined or received information indicating that the vehicles propulsion system or brake system is operating in a limited or degraded state. According to some embodiments, the system may calculate individual brake torque requests based on magnitude. As a non-limiting example, based on inputs received by the system such as, but not limited to, obstacles in adjacent vehicle lanes or in front or behind a vehicle correlated against known vehicle speed and current trajectory, the system may generate and communicate brake torque requests to the braking system to slow the vehicle minorly, moderately, or majorly for a calculated period of time. As a non-limiting example, based on inputs received by the system, such as, but not limited to, a disabled propulsion system, the system may determine that emergency stop functionality is required By communicating brake torque requests to the braking system to bring the vehicle to complete stop. Alternatively, as an additional non limiting example, based on inputs received by the system, such as, but not limited to, a disabled braking system, the system may determine that emergency stop functionality is required by communicating propulsion torque requests to the propulsion system to reduce vehicle speed.

According to some embodiments, at least one controller may implement emergency stop functionality to bring a vehicle to a controlled stop When a vehicle's brake system, propulsion system, steering system, or motion control system are operating in a degraded state or are disabled or are unavailable. Emergency stop functionality may be implemented when autonomous path trajectory or path planning is unavailable. According to some embodiments, the system may additionally apply the parking brake within a vehicle after the vehicle has reached a complete stop.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a method of determining individual wheel brake torque or propulsion torque may include at least one of vehicle propulsion system status, vehicle brake system status, vehicle speed data, surface mu information, local object location data via a first plurality of sensors, last known steering positions, steering system status, motion control system status, autonomous mode status, emergency stop request from vehicle level automated driving system, autonomous path trajectory availability status, or current and last known autonomous path trajectory information. The method may further include determining if an autonomous driving mode is active and determining availability of emergency stop request by monitoring at least one of propulsion system state, brake system state, valid vehicle speed, valid surface mu information, valid local object location data, last known steering positions, steering system status, motion control system status, autonomous mode status, emergency stop request from vehicle level automated driving system, autonomous path trajectory availability status, or current or last known autonomous path trajectory information. The method may further include outputting availability of emergency stop request to an emergency stop request activation module, the emergency stop request activation module being constructed and arranged to determine if at least one of a steering system is disabled, a motion control system is disabled, an autonomous path trajectory is unavailable, the propulsion system is disabled, the brake system is disabled, or emergency stop request from vehicle level ADS is present; activate emergency stop functionality; and calculate at least one of propulsion torque or individual wheel brake torque based on at least one of vehicle speed data, surface mu information, local object location data, or last known steering position.

Variation 2 may include a method as in variation 1 including applying the at least one of propulsion torque or individual wheel brake torque to stop a vehicle.

Variation 3 may include a method as in any of variations 1 through 2, further including receiving last known trajectory information.

Variation 4 may include a method as in any of variations 1 through 3, further including receiving health state of steering system state, motion control system state.

Variation 5 may include a method as in any of variations 1 through 4, further including receiving emergency brake requests from an autonomous driving system.

Variation 6 may include a method as in any of variations 1 through 5, further including communicating an emergency stop request to at least one of a plurality of controllers prior to activating emergency stop functionality.

According to variation 7, a method may include receiving at least one of vehicle propulsion system status, vehicle brake system status, vehicle speed data, surface mu information, or local object location data via a first plurality of sensors; determining availability of emergency stop request by monitoring at least one of or using at least one default values for at least one of propulsion system state, brake system state, valid vehicle speed, valid surface mu information, or valid local object location data; and determining availability of emergency stop request by monitoring at least one of last known steering positions, steering system status, motion control system status, autonomous mode status, emergency stop request from vehicle level automated driving system, autonomous path trajectory availability status, or current or last known autonomous path trajectory information. The method may further include outputting availability of emergency stop request to an emergency stop request activation module, the emergency stop request activation module being constructed and arranged to calculate at least one of propulsion torque or individual wheel brake torque based on at least one of vehicle speed data, surface mu information, local object location data, or last known steering position; generate an emergency stop request; communicate the emergency stop request to an autonomous driving system; and activating emergency stop functionality accounting for calculated at least one of propulsion torque or individual wheel brake torque.

Variation 8 may include a method as in variation 7, further including receiving last known trajectory information.

Variation 9 may include a method as in any of variations 7 through 8, further including receiving health state of steering system state, motion control system state.

Variation 10 may include a method as in any of variations 7 through 9, further including receiving last known steering positions.

Variation 11 may include a method as in any of variations 7 through 10, further including receiving emergency brake requests from an autonomous driving system.

Variation 12 may include a method as in any of variations 7 through 11, further including communicating an emergency stop request to at least one of a plurality of controllers prior to activating emergency stop functionality.

Variation 13 may include a method as in any of variations 7 through 12, further including generating at least one of a brake request or propulsion request accounting for calculated at least one of propulsion torque or individual wheel brake torque prior to generating an emergency stop request.

According to variation 14, a method may include implementing at least one computing device in operable communication with a vehicle communication network; implementing a memory that stores computer-executable components; and implementing a processor that executes the computer-executable components stored in the memory. The computer-executable components may include receiving vehicle propulsion system status; receiving vehicle brake system status; receiving vehicle speed data; receiving surface mu information; receiving local object location data via a first plurality of sensors; receiving steering system status; receiving motion control system status; receiving autonomous mode active/inactive status; receiving emergency stop request from vehicle level automated driving system; receiving autonomous path trajectory availability/unavailability status; and receiving current and last known autonomous path trajectory information. The method may further include determining if an autonomous driving mode is active; outputting autonomous driving mode active state to an emergency stop request activation module; determining availability of emergency stop request by monitoring at least one of propulsion system state, brake system state, valid vehicle speed, valid surface mu information, or valid local object location data; outputting availability of emergency stop request to the emergency stop request activation module. The emergency stop request activation module may be constructed and arranged to determine if at least one of a steering system is disabled, a motion control system is disabled, an autonomous path trajectory is unavailable, the propulsion system is disabled, a brake system is disabled, or an autonomous driving mode is active; activate emergency stop functionality; calculate at least one of propulsion torque or individual wheel brake torque based on at least one of vehicle speed data, surface mu information, local object location data, or last known steering position; generate at least one of a brake request or propulsion request accounting for calculated at least one of propulsion torque or individual wheel brake torque; generate an emergency stop request; communicate the emergency stop request to an autonomous driving system over the vehicle communication network; and perform an emergency stop accounting for the at least one generated brake request or propulsion request.

Variation 15 may include a method as in variation 14, further including receiving last known trajectory information.

Variation 16 may include a method as in any of variations 14 through 15, further including receiving health state of steering system state or motion control system state.

Variation 17 may include a method as in any of variations 14 through 16, further including receiving last known steering positions.

Variation 18 may include a method as in any of variations 14 through 17, further including receiving emergency brake requests from an autonomous driving system.

Variation 19 may include a method as in any of variations 14 through 18, further including communicating an electronic parking brake request to a parking brake module after performing an emergency stop accounting for the at least one generated brake request or propulsion request.

Variation 20 may include a method as in any of variations 14 through 19, wherein generating at least one of a brake request or propulsion request accounting for calculated at least one of propulsion torque or individual wheel brake torque includes modifying at least one existing brake torque request or at least one existing propulsion torque request.

The above description of select variations within the scope of the invention is merely illustrative in nature and, thus, variations or variants thereof are not to be regarded as a departure from the spirit and scope of the invention.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method of determining individual wheel brake torque or propulsion torque comprising:
receiving at least one of vehicle propulsion system status, vehicle brake system status, vehicle speed data, surface mu information, local object location data via a first plurality of sensors, last known steering positions, steering system status, motion control system status, autonomous mode status, emergency stop request from vehicle level automated driving system, autonomous path trajectory availability status, or current and last known autonomous path trajectory information;
determining if an autonomous driving mode is active;
determining availability of emergency stop request by monitoring at least one of propulsion system state, brake system state, valid vehicle speed, valid surface mu information, valid local object location data, last known steering positions, steering system status, motion control system status, autonomous mode status, emergency stop request from vehicle level automated driving system, autonomous path trajectory availability status, or current or last known autonomous path trajectory information;
outputting availability of emergency stop request to an emergency stop request activation module, the emergency stop request activation module being constructed and arranged to:
determine if at least one of a steering system is disabled, a motion control system is disabled, an autonomous path trajectory is unavailable, the propulsion system is disabled, the brake system is disabled, or emergency stop request from vehicle level ADS;
activate emergency stop functionality; and
calculate at least one of propulsion torque or individual wheel brake torque based on at least one of vehicle speed data, surface mu information, local object location data, or last known steering position.

2. A method of determining individual wheel brake torque or propulsion torque as in claim 1, further comprising applying the at least one of propulsion torque or individual wheel brake torque to stop a vehicle.

3. A method of determining individual wheel brake torque or propulsion torque as in claim 1, further comprising receiving last known trajectory information.

4. A method of determining individual wheel brake torque or propulsion torque as in claim 1, further comprising receiving health state of steering system state, motion control system state.

5. A method of determining individual wheel brake torque or propulsion torque as in claim 1, further comprising receiving emergency brake requests from an autonomous driving system.

6. A method of determining individual wheel brake torque or propulsion torque as in claim 1, further comprising communicating an emergency stop request to at least one of a plurality of controllers prior to activating emergency stop functionality.

7. A method of determining individual wheel brake torque or propulsion torque comprising:
receiving at least one of vehicle propulsion system status, vehicle brake system status, vehicle speed data, surface mu information, or local object location data via a first plurality of sensors;
determining availability of emergency stop request by monitoring at least one of or using at least one default values for at least one of propulsion system state, brake system state, valid vehicle speed, valid surface mu information, or valid local object location data;
determining availability of emergency stop request by monitoring at least one of last known steering positions, steering system status, motion control system status, autonomous mode status, emergency stop request from vehicle level automated driving system, autonomous path trajectory availability status, or current or last known autonomous path trajectory information;
outputting availability of emergency stop request to an emergency stop request activation module, the emergency stop request activation module being constructed and arranged to:
calculate at least one of propulsion torque or individual wheel brake torque based on at least one of vehicle speed data, surface mu information, local object location data, or last known steering position;
generate an emergency stop request;
communicate the emergency stop request to an autonomous driving system; and
activating emergency stop functionality accounting for calculated at least one of propulsion torque or individual wheel brake torque.

8. A method of determining individual wheel brake torque or propulsion torque as in claim 7, further comprising receiving last known trajectory information.

9. A method of determining individual wheel brake torque or propulsion torque as in claim 7, further comprising receiving health state of steering system state, motion control system state.

10. A method of determining individual wheel brake torque or propulsion torque as in claim 7, further comprising receiving last known steering positions.

11. A method of determining individual wheel brake torque or propulsion torque as in claim 7, further comprising receiving emergency brake requests from an autonomous driving system.

12. A method of determining individual wheel brake torque or propulsion torque as in claim 7, further comprising communicating an emergency stop request to at least one of a plurality of controllers prior to activating emergency stop functionality.

13. A method of determining individual wheel brake torque or propulsion torque as in claim 7, further comprising generating at least one of a brake request or propulsion request accounting for calculated at least one of propulsion torque or individual wheel brake torque prior to generating an emergency stop request.

14. A method of determining individual wheel brake torque or propulsion torque comprising:
implementing at least one computing device in operable communication with a vehicle communication network;
implementing a memory that stores computer-executable components;
implementing a processor that executes the computer-executable components stored in the memory, wherein the computer-executable components comprise:
receiving at least one of vehicle propulsion system status;
receiving vehicle brake system status;
receiving vehicle speed data;
receiving surface mu information;
receiving local object location data via a first plurality of sensors;
receiving steering system status;
receiving motion control system status;
receiving autonomous mode active/inactive status;
receiving emergency stop request from vehicle level automated driving system;
receiving autonomous path trajectory availability/unavailability status;
receiving current and last known autonomous path trajectory information;
determining if an autonomous driving mode is active;
outputting autonomous driving mode active state to an emergency stop request activation module;
determining availability of emergency stop request by monitoring at least one of propulsion system state, brake system state, valid vehicle speed, valid surface mu information, or valid local object location data;
outputting availability of emergency stop request to the emergency stop request activation module, the emergency stop request activation module being constructed and arranged to:
determine if at least one of a steering system is disabled, a motion control system is disabled, an autonomous path trajectory is unavailable, the propulsion system is disabled, a brake system is disabled, or an autonomous driving mode is active;
activate emergency stop functionality;
calculate at least one of propulsion torque or individual wheel brake torque based on at least one of vehicle speed data, surface mu information, local object location data, or last known steering position;
generate at least one of a brake request or propulsion request accounting for calculated at least one of propulsion torque or individual wheel brake torque;
generate an emergency stop request;
communicate the emergency stop request to an autonomous driving system over the vehicle communication network; and
perform an emergency stop accounting for the at least one generated brake request or propulsion request.

15. A method of determining individual wheel brake torque or propulsion torque as in claim 14, further comprising receiving last known trajectory information.

16. A method of determining individual wheel brake torque or propulsion torque as in claim 14, further comprising receiving health state of steering system state or motion control system state.

17. A method of determining individual wheel brake torque or propulsion torque as in claim 14, further comprising receiving last known steering positions.

18. A method of determining individual wheel brake torque or propulsion torque as in claim 14, further comprising receiving emergency brake requests from an autonomous driving system.

19. A method of determining individual wheel brake torque or propulsion torque as in claim 14, further comprising communicating an electronic parking brake request to a parking brake module after performing an emergency stop accounting for the at least one generated brake request or propulsion request.

20. A method of determining individual wheel brake torque or propulsion torque as in claim 14, wherein generating at least one of a brake request or propulsion request accounting for calculated at least one of propulsion torque or individual wheel brake torque comprises modifying at least one existing brake torque request or at least one existing propulsion torque request.
